(19) United States
(12) Patent Application Publication
(10) Pub. No.: US 2024/0185088 A1
(43) Pub. Date: Jun. 6, 2024

(54) SCALABLE WEIGHT REPARAMETERIZATION FOR EFFICIENT TRANSFER LEARNING

(71) Applicant: QUALCOMM Incorporated, San Diego, CA (US)

(72) Inventors: Byeonggeun KIM, Seoul (KR); Juntae LEE, Seoul (KR); Seunghan YANG, Incheon (KR); Simyung CHANG, Suwon (KR)

(21) Appl. No.: 18/323,197

(22) Filed: May 24, 2023

Related U.S. Application Data
(60) Provisional application No. 63/380,805, filed on Oct. 25, 2022.

(51) Int. Cl. G06N 3/0985; G06N 3/045; G06N 3/048

(52) U.S. Cl. CPC G06N 3/0985; G06N 3/045; G06N 3/048

(57) ABSTRACT

Certain aspects of the present disclosure provide techniques and apparatus for scalable weight reparameterization for efficient transfer learning. One example method generally includes training a first neural network to perform a task based on weights defined for a machine learning (ML) model trained to perform a different task and learned reparameterizing weights for each of a plurality of layers in the ML model; training a second neural network to generate a plurality of gating parameters based on a cost factor and the trained first neural network, each respective gating parameter of the plurality of gating parameters corresponding to weights in a respective layer of the plurality of layers; and updating the ML model based on the weights defined for the ML model, each gating parameter for each layer of the plurality of layers, and the learned reparameterizing weights for each layer of the plurality of layers.

### CROSS-REFERENCE TO RELATED APPLICATIONS

This application claims priority to and benefit of U.S. Provisional Patent Application Ser. No. 63/380,805, entitled “Scalable Weight Reparametrization for Efficient Transfer Learning,” filed Oct. 25, 2022, and assigned to the assignee hereof, the entire contents of which hereby are incorporated by reference.

### INTRODUCTION

Aspects of the present disclosure relate to transfer learning.

Transfer learning may be useful in various fields, such as computer vision, natural language processing, audio processing, and the like. In transfer learning, machine learning models pre-trained on large-scale datasets can leverage the knowledge obtained from one dataset to perform a different but related task (e.g., transferring classification-related knowledge for classifying one type of object to classifying a different type of object in image data). To perform transform learning, the layers of the machine learning model or the last classification layer can be finetuned in order to adjust a pre-trained model for a downstream task different from the original task for which the model was trained. Finetuning the layers of the machine learning model generally produces a separate copy of the pre-trained model parameters for each task. Although generating different versions of the pre-trained model parameters for different tasks may be a useful approach, efficiency may decrease as the number of downstream tasks for which a model is trained increases. Such finetuning may be computationally expensive, leading such models to be impractical or infeasible to implement for deployment on memory-constrained systems (e.g., edge devices, such as mobile phones). Finetuning the last classification layer in a machine learning model may be less computationally expensive, but may result in lower inference performance on downstream tasks than finetuning more than the last classification layer in the machine learning model.

To improve the efficiency and performance of machine learning models trained using transfer learning, additional task-specific modules may be deployed together with the pre-trained machine learning model. In such approaches, it is difficult to determine how many task-specific modules are to be added to the machine learning model and where in the machine learning model to place these extra task-specific modules. In some approaches, a policy network is introduced for flexible use of these extra task-specific modules; however, each instance of a task-specific module may be configured to pass the output of the policy network through. In both of these cases, the addition of these task-specific models and the use of a policy network may adversely affect the computational efficiency of transfer learning.

### BRIEF SUMMARY

Certain aspects generally relate to scalable weight reparameterization for efficient transfer learning.

Certain aspects provide a processor-implemented method for training a machine learning model based on weight reparameterization and transfer learning. The method generally includes training a first neural network to perform a task based on weights defined for a machine learning model trained to perform a different task and learned reparameterizing weights for each of a plurality of layers in the machine learning model; training a second neural network to generate a plurality of gating parameters based on a cost factor and the trained first neural network, each respective gating parameter of the plurality of gating parameters corresponding to weights in a respective layer of the plurality of layers in the machine learning model; and updating the machine learning model based on the weights defined for the machine learning model, each gating parameter for each layer of the plurality of layers in the machine learning model, and the learned reparameterizing weights for each layer of the plurality of layers in the machine learning model.

Certain aspects provide a processor-implemented method for inferencing using a machine learning model trained based on weight reparameterization and transfer learning. The method generally includes extracting features from an input for which an inference is to be generated; generating the inference based on the extracted features from the input and a machine learning model having weights defined for each respective layer in the machine learning model based on base weights defined for each respective layer in the machine learning model, a gating parameter for each respective layer in the machine learning model, and reparameterizing weights for each respective layer in the machine learning model; and taking one or more actions based on the generated inference.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and apparatus comprising means for performing the aforementioned methods as well as those further described herein.

The following description and the related drawings set forth in detail certain illustrative features of one or more aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 depicts an example pipeline for weight reparameterization for transfer learning, in accordance with aspects of the present disclosure.

FIG. 2 illustrates example reparameterized layers with and without the use of cost-based regularization, in accordance with aspects of the present disclosure.

FIG. 3 illustrates example operations for training a machine learning model based on weight reparameterization in transfer learning, in accordance with aspects of the present disclosure.

FIG. 4 illustrates example operations for inferencing using a machine learning model trained based on weight reparameterization in transfer learning, in accordance with aspects of the present disclosure.

FIG. 5 illustrates an example system on which aspects of the present disclosure may be executed, in accordance with aspects of the present disclosure.

FIG. 6 illustrates an example system on which aspects of the present disclosure may be executed, in accordance with aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for scalable weight reparameterization for efficient transfer learning.

Transfer learning may be useful in various fields, such as computer vision, natural language processing, and audio processing and/or analysis, with machine learning models pre-trained on large-scale datasets to leverage the knowledge gained while training a machine learning model to perform an initial task. Finetuning the layers of the machine learning model or the last classification layer is used in some cases, in order to transfer a pre-trained machine learning model to a downstream task (e.g., adapt the pre-trained machine learning model to perform a task different from the original task for which the machine learning model was initially trained). As discussed, finetuning the layers produces a separate copy of the pre-trained model parameters for each task, while finetuning the last classification layer may reduce the computational expense of transfer learning at the expense of inference performance on downstream tasks (e.g., tasks other than the original task for which the machine learning model was trained).

To improve the efficiency of transfer learning and maintain inference accuracy across different tasks (e.g., the original task for which a machine learning model is trained, as well as the downstream tasks for which the machine learning model is trained using transfer learning), various approaches have been used. One approach involves the use of additional task-specific modules which are deployed with the pre-trained machine learning model. Another approach involves the use of a policy network to allow for flexible use of these additional task-specific modules. These techniques, however, may be computationally expensive, inefficient, or impractical to deploy.

Aspects of the present disclosure provide techniques for using scalable weight reparameterization for efficiency-controllable transfer learning. In some aspects, weight reparameterization may be performed by adding a learnable weight term to each pre-trained weight to obtain a task-specific weight. In such aspects, a policy network may manage whether or not to apply the weight reparameterization for the layers under an efficiency constraint. Scalable weight reparameterization may improve the performance of transfer learning operations and inference performance of models trained using transfer learning techniques while satisfying diverse expected efficiency metrics for models of varying sizes and on varying benchmarks.

### Example Scalable Weight Reparameterization

In transfer learning, a pre-trained feature extractor, f₀, may be trained to perform T downstream tasks based on corresponding training data sets, D₁, D₂, . . . , D_{T}, where Dₜ={xᵢ,yᵢ}ᵢ₌₁^{N}^{ₜ}. Each sample i in a training data set D generally includes an example xᵢ and a corresponding label yᵢ. Since the label sets of different tasks do not need to overlap, these label sets may have different class sets. For transfer learning to a downstream task t, t∈T, the pre-trained feature extractor f₀ is updated to a task-specific feature extractor fₜ, and task-specific classifier g t is newly learned. A goal of transfer learning may be to find fₜ and gₜ optimized to the corresponding objective and satisfy the constrained amount of updated weights for efficiency at multi-task transferring. In some cases, fₜ contains the same number of parameters as f₀, which may minimize the increase in computational complexity between different tasks.

For a learnable layer l∈{1, . . . , L} of a task-specific feature extractor fₜ, where L corresponds to the number of learnable layers in f t , the pretrained weight wₗ⁰ may be frozen. Scalable weight parameterization generates the transferred weight wₗ based on a learnable reparameterizing weight w′ₗ in accordance with the following equation:

wₗ=wₗ⁰+bₗw′ₗ (1)

where bₗ∈{0, 1} is a policy that decides if the l^{th} layer weight is reparameterized or not. w′ₗ is zero-initialized to let wₗ⁰ start from wₗ⁰. All the learnable layers in the feature extractor fₜ may be reparameterized except batch normalization layers.

To obtain the policies bₗ, a policy network (policynet) h may be designed, including three linear layers with a rectified linear unit (ReLU). The policynet takes a target cost (c∈[0, 1]) as an input, where the higher the c, the more task-specific weights are desired over the frozen, pretrained weights. The policy network may generally yield L two-dimensional outputs, {hₗ(c)}ₗ₌₁^{L}, where the first element is binarized as the policy by a threshold (e.g., of 0.5) for each layer l in the machine learning model. When the resulting policy value bₗ is 1 in an l^{th} layer, wₗ⁰ is replaced with the task-specifically learned wₗ.

In training, to make the layer-wise binary policy differentiable, discrete policies may be relaxed to continuous variables using a hard Gumbel-Softmax function for each layer 1 in the machine learning model, according to the equation:

bₗ=Gumbel (hₗ(c)/τ)₁ (2)

where τ is a softmax temperature and 1 indicates the first element. The size of a weight wₗ may be the same as a weight wₗ⁰, and the policynet 116 may be omitted as part of the deployed machine learning model. Because the policynet 116 may be omitted in the deployed model, additional computation need not be performed at inference time to determine whether to use the frozen baseline weights or reparameterized weights in any given layer of the model for any given task t of the multiple T tasks for which the machine learning model is trained. For a number of tasks T, the increase in the number of parameters used by the model may be proportional to the number of task-specific parts, which can be adjusted through the use of different values of c (e.g., as discussed above, with smaller values of c (e.g., values closer to 0) indicating a preference for the frozen baseline weights (potentially at the expense of inference performance) and larger values of c indicating a preference for reparameterized weights (potentially at the expense of computational complexity).

As discussed above, some approaches may update affine transformation parameters, as well as running mean and variance in batch normalization (BN) layers for each downstream task. However, the cost of these transformations may be significant, for example, in relation to the overall computational expense of training and inferencing using small networks (e.g., networks with a small number of layers and/or neurons). Aspects of the present disclosure, however, provide techniques for updating the running mean and variance while freezing affine parameters to reduce the number of updated parameters, thus providing improvements in the performance of transfer learning and in inference using models trained using transfer learning.

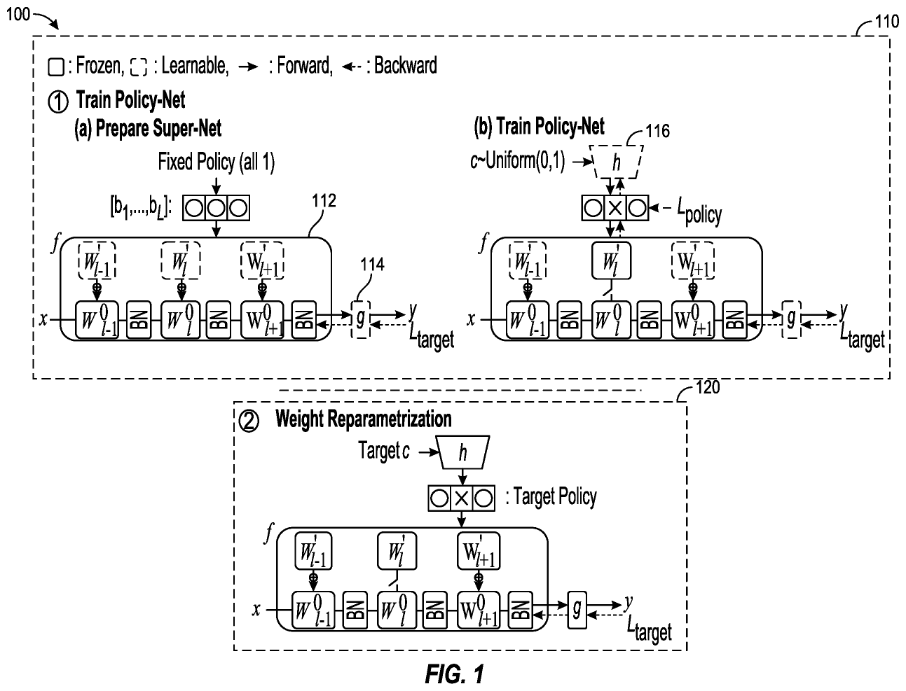

FIG. 1 depicts an example pipeline 100 for training a machine learning model based on transfer learning and scalable weight reparameterization, in accordance with aspects of the present disclosure. As illustrated, pipeline 100 includes a transfer learning stage 110 and a weight reparameterization stage 120.

Generally, the transfer learning stage 110 includes a feature extractor f 112, a classifier g 114, and a policy network (also referred to as a “policynet”) h 116. Given a downstream task t∈T, c may be defined as the target cost for f 112 after transfer learning, and b may be defined as the binary policies for the L layers of the machine learning model. As illustrated in the example, the policynet 116 is trained based on a supernet, or neural network in which each neuron in the network corresponds to a discrete neural network, including the feature extractor f 112 and the classifier g 114, which finetunes the L layers of the machine learning model.

As illustrated, feature extractor f 112 includes a plurality of layers associated with weights w. Each combination of an input x and weight w may be processed through a batch normalization block within the feature extractor f 112. The batch-normalized output of the final layer of the feature extractor f 112 may be processed through a classifier g 114 in order to generate a classification of the input x.

Co-optimizing h and {w′ₗ}ₗ₌₁^{L} may result in poor convergence. Aspects of the present disclosure provide techniques for two-stage training, which may prevent such poor convergence. In some cases, policynet 116 may be trained with a supernet. To generate a reliable policynet, a target downstream task (e.g., a task for which a pre-trained model is being adapted using transfer learning techniques) can be learned using a supernet including the feature extractor f 112 and classifier g 114, where the weights in the pre-trained model are transferred according to the equation wₗ=wₗ⁰+w′ₗ. That is, in training the policynet 116, the policy is set such that each element of the policy [b₁, . . . , b_{L}] is set to 1 in Equation (1). The policynet 116 may initially be trained to calculate reparameterized weights w′ for each layer in the model. Hence, at this stage of training, the policynet 116 may be effectively disregarded, and the supernet may be trained based on a target task loss L_{target} (e.g., cross-entropy loss). After the supernet is trained, the supernet may be frozen, and a policynet h 116 may be trained by varying the target cost input c˜Uniform(0, 1). An additional loss term [symbol] _{policy} may be used to train the policynet, as shown in the following equation:

$${ℒ}_{policy} = \vert \{ {\sum }_{l = 1}^{L} {r}_{l} \cdot Soft {max ( {h}_{l} ( c ) / τ )}_{1} \} - c \vert \qquad ( 3 )$$

where rₗ=|wₗ|/Σᵢ₌₁^{L}|wᵢ| corresponds to a normalized layer-wise weighting according to |wₗ|, the norm of wₗ, which indicates the number of parameters in wₗ·rₗ makes [symbol] _{policy} consider the cost of layer l based on |wₗ|. As shown above, a typical softmax layer may be used in place of a Gumbel-softmax layer in computing [symbol] _{policy}. The total loss may be defined according to the equation:

[symbol]

= [symbol] _{target}+λ· [symbol] _{policy},

where λ corresponds to a training hyperparameter defined for the neural network. Policynet h 116 may identify policies to impose on the transfer of weights from a pre-trained feature extractor f and a task-specific feature extractor fₜ such that the policy defines which weights are transferred (e.g., where b=1) and which weights are not transferred (e.g., where b=0, illustrated as a x and leading to a disconnected gate between w′ and w in FIG. 1). Two-stage training as disclosed herein may improve optimization of h and wₗ′.

At weight reparameterization stage 120, after the policynet 116 is trained by the supernet (e.g., the network including the feature extractor f 112 and classifier g 114), which finetunes the L layers of the machine learning model, the layers are updated by weight reparameterization for a target c.

To perform weight reparameterization, the policynet 116 may be frozen and may generate 0 or 1 binarized policies using a threshold (e.g., a threshold of 0.5) given a target cost level c. Reparameterized weights wₗ′ with corresponding policies set to 1 may be learned with [symbol] _{target}. In this case, weight rewinding may be performed (e.g., by performing zero initialization for every wₗ′ instead of using the learned supernet parameters).

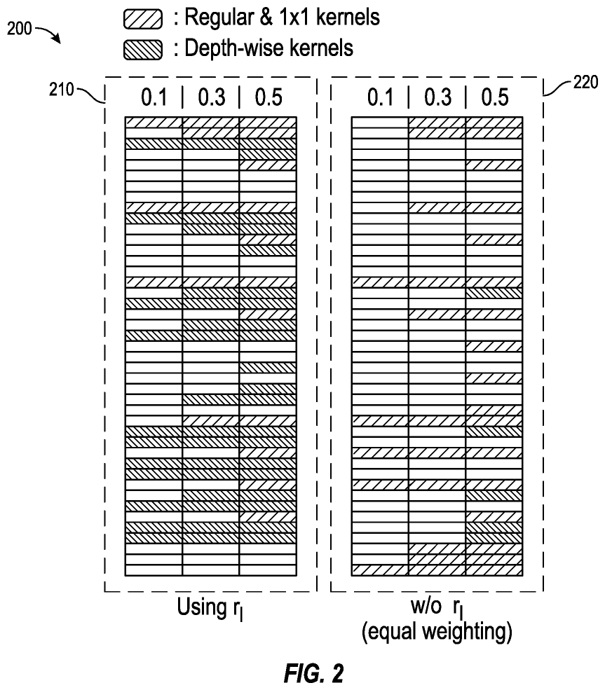

FIG. 2 illustrates example reparameterized layers 200 with and without the use of cost-based regularization, in accordance with certain aspects of the present disclosure. FIG. 2 illustrates a resulting policy for a number of convolutional layers in a machine learning model trained using transfer learning techniques for different cost factors (e.g., of 0.1, 0.3, 0.5). As illustrated, cost increases from left to right, and the layers of the machine learning model are organized from shallow layers to deeper layers from top to bottom.

As illustrated by chart 210, by using a regularization factor, the layers which may be transferred from the pretrained model f₀ may increase in number as the cost factor increases, and a majority of the layers transferred from the pretrained model f₀ may be depth-wise kernels, with relatively few regular or 1×1 kernels transferred from the pretrained model f₀. Where a regularization factor is not used, as illustrated by chart 220, layers in the machine learning model are equally weighted. Thus, fewer depth-wise kernels may be transferred, while more regular or 1×1 kernels may be transferred (as these kernels may be less computationally complex and thus more amenable to transfer in an equal weight scheme).

### Example Operations for Scalable Weight Reparameterization for Efficient Transfer Learning

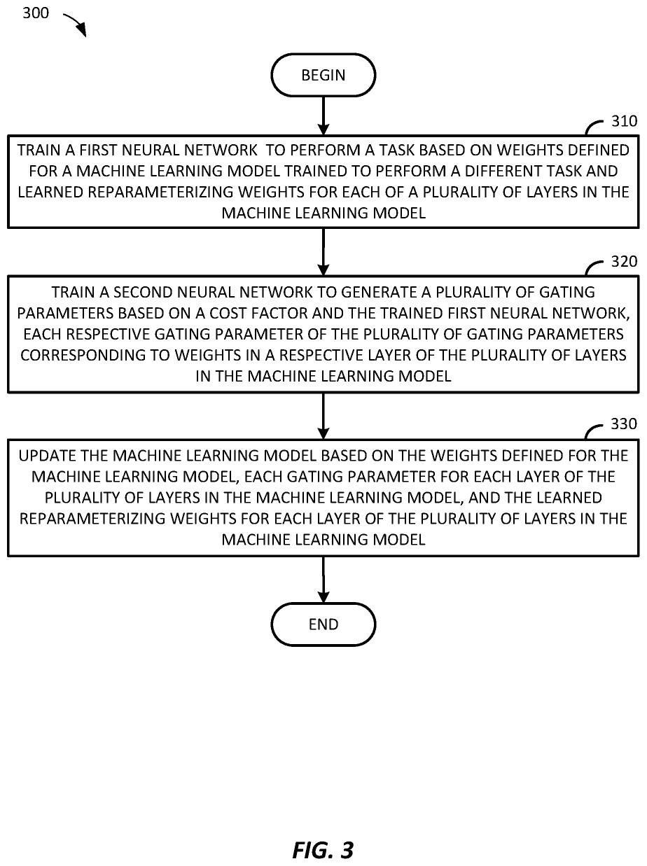

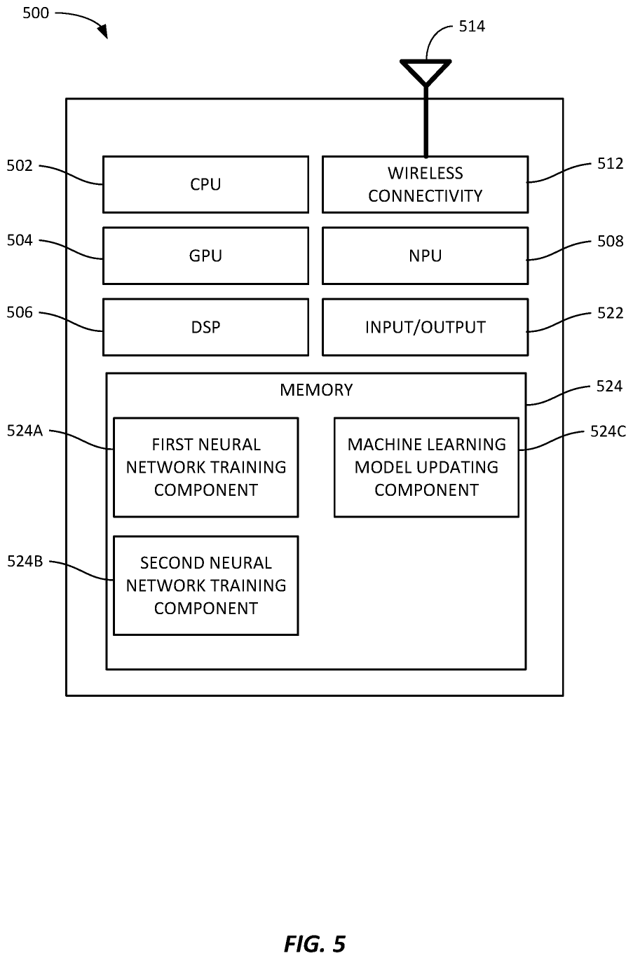

FIG. 3 shows an example of operations 300 for scalable weight reparameterization for efficient transfer learning, in accordance with aspects of the present disclosure. In some examples, operations 300 may be performed by a device, such as the processing system 500 illustrated in FIG. 5.

As illustrated, operations 300 begin at block 310 with training a first neural network to perform a task based on weights defined for a machine learning model trained to perform a different task and learned reparameterizing weights for each of a plurality of layers in the machine learning model. In some aspects, the first neural network may be trained with a target task loss value.

Operations 300 proceed to block 320 with training a second neural network to generate a plurality of gating parameters (also referred to as policies, discussed above with respect to FIG. 1) based on a cost factor and the trained first neural network. Each respective gating parameter of the plurality of gating parameters may correspond to weights in a respective layer of the plurality of layers in the machine learning model.

In some aspects, the second neural network may be trained based on a target cost input and a policy loss value. The policy loss value is calculated based on an average Gumbel loss over the plurality of layers in the machine learning model and the target cost input. In some aspects, the average Gumbel loss comprises an average of a product of a layer-wise weighting for a respective layer in the machine learning model based on a number of parameters in the weights defined for the machine learning model and a Gumbel loss for the respective layer. In some aspects, a total loss used in training the second neural network is based on a target task loss value and a product of the policy loss value and a loss weighting hyperparameter.

In some aspects, the second neural network comprises a network including a plurality of linear layers and a non-linear layer comprising a rectified linear unit (ReLU).

Operations 300 proceed to block 330 with updating the machine learning model based on the weights defined for the machine learning model, each gating parameter for each layer of the plurality of layers in the machine learning model, and the learned reparameterizing weights for each layer of the plurality of layers in the machine learning model.

In some aspects, updating the machine learning model may include binarizing the generated plurality of gating parameters. For example, a gating parameter for a respective layer that is less than a threshold value may be configured such that weights are not modified for the respective layer. Meanwhile, a gating parameter for the respective layer that is greater than the threshold value may be configured such that weights are modified for the respective layer by a respective learned reparameterizing weight.

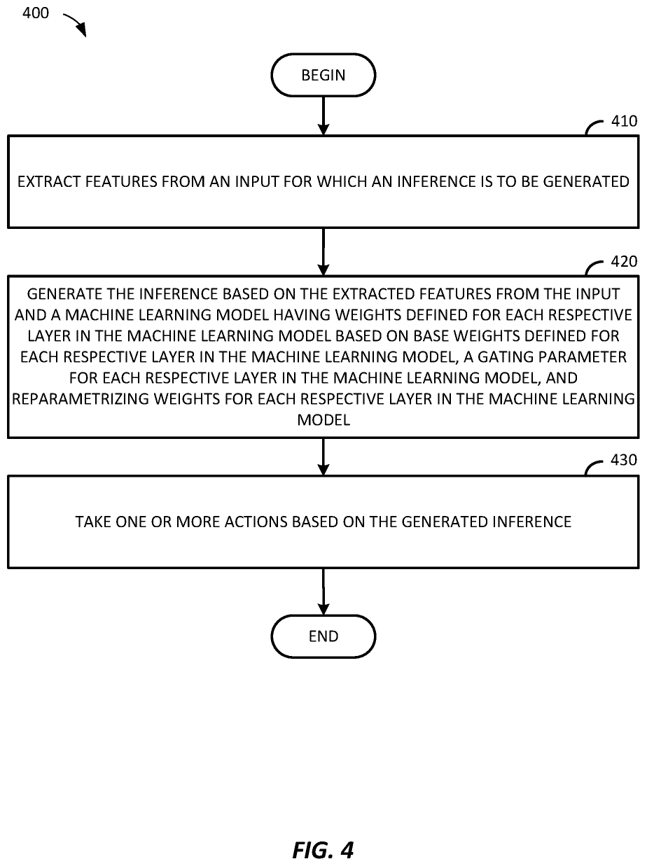

FIG. 4 illustrates example operations 400 for inferencing using a machine learning model trained based on weight reparameterization in transfer learning, in accordance with aspects of the present disclosure. Operations 400 may be performed, for example, by a device on which inferences are to be performed based on input data, such as a smartphone, a tablet computer, a laptop computer, one or more computing devices deployed on an autonomous vehicle, or the like.

As illustrated, operations 400 begin at block 410 with extracting features from an input for which an inference is to be generated.

Operations 400 proceed to block 420 with generating the inference based on the extracted features from the input and a machine learning model having weights defined for each respective layer in the machine learning model based on base weights (or weights in a pre-trained model based on which a task-specific model is generated) defined for each respective layer in the machine learning model, a gating parameter for each respective layer in the machine learning model, and reparameterizing weights for each respective layer in the machine learning model.

In some aspects, the machine learning model comprises a model having been generated based on a first neural network trained based on a target loss value and a second neural network trained based on a target cost input and a policy loss value.

In some aspects, the policy loss value is calculated based on an average Gumbel loss over the plurality of layers in the machine learning model and the target cost input. The second neural network may further be trained based on a target task loss value and a product of the policy loss value and a loss weighting hyperparameter.

In some aspects, the machine learning model comprises a plurality of transferred layers from a base machine learning model identified based on a binarization of a plurality of gating parameters. For example, a gating parameter for a respective layer that is less than a threshold value may be configured such that weights are not modified for the respective layer. Meanwhile, a gating parameter for the respective layer that is greater than the threshold value may be configured such that weights are modified for the respective layer by a respective learned reparameterizing weight.

In some aspects, the machine learning model comprises a network including a plurality of linear layers and a non-linear layer comprising a rectified linear unit (ReLU).

Operations 400 proceed to block 430 with taking one or more actions based on the generated inference. Generally, the one or more actions may be an action different from an action for which the machine learning model was originally trained.

In some aspects, the one or more actions include segmenting visual content into one or more segments. In this case, each segment of the one or more segments may correspond to different classes of objects present in a scene captured in the visual content. The one or more actions may further include controlling one or more physical devices based on the segmented visual content.

### Example Processing Systems for Scalable Weight Reparameterization for Efficient Transfer Learning

FIG. 5 depicts an example processing system 500 for scalable weight reparameterization for efficient transfer learning, such as described herein for example with respect to FIG. 3.

Processing system 500 includes a central processing unit (CPU) 502, which in some examples may be a multi-core CPU. Instructions executed at the CPU 502 may be loaded, for example, from a program memory associated with the CPU 502 or may be loaded from a memory 524.

Processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the plurality of NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, NPU 508 is a part of one or more of CPU 502, GPU 504, and/or DSP 506.

In some examples, wireless connectivity component 512 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 512 is further connected to one or more antennas 514.

Processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of processing system 500.

In particular, in this example, memory 524 includes first neural network training component 524A, second neural network training component 524B, and machine learning model updating component 524C. The depicted components, and others not depicted, may be configured to perform various aspects of the methods described herein.

Generally, processing system 500 and/or components thereof may be configured to perform the methods described herein.

Notably, in other aspects, aspects of processing system 500 may be omitted, such as where processing system 500 is a server computer or the like. Further, aspects of processing system 500 may be distributed, such as training a model and using the model to generate inferences, such as user verification predictions.

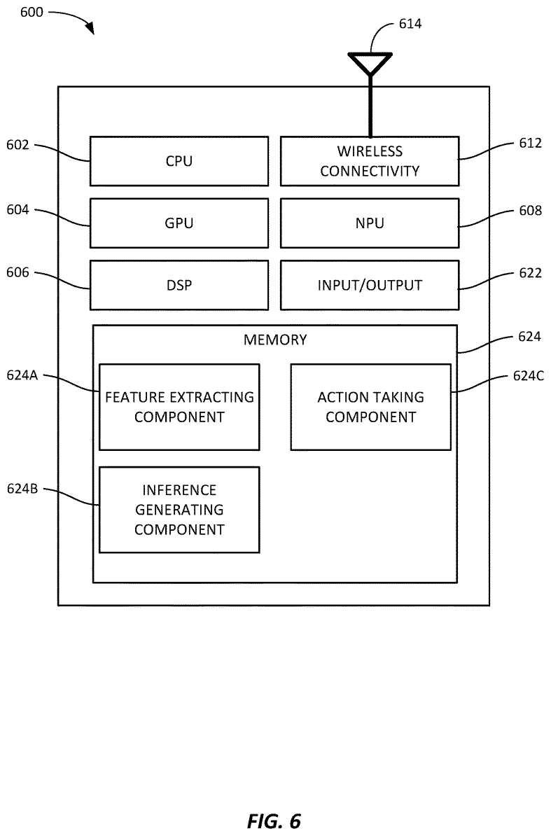

FIG. 6 depicts an example processing system 600 for inferencing using a machine learning model generated based on transfer learning and scalable weight reparameterization for efficient transfer learning, such as described herein for example with respect to FIG. 4.

Processing system 600 includes a central processing unit (CPU) 602, which in some examples may be a multi-core CPU. Instructions executed at the CPU 602 may be loaded, for example, from a program memory associated with the CPU 602 or may be loaded from a memory 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), a tensor processing unit (TPU), neural network processor (NNP), intelligence processing unit (IPU), vision processing unit (VPU), or graph processing unit.

NPUs, such as NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the plurality of NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 6G or NR), Wi-Fi connectivity, Bluetooth connectivity, and other wireless data transmission standards. Wireless connectivity component 612 is further connected to one or more antennas 614.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes feature extracting component 624A, inference generating component 624B, and action taking component 624C. The depicted components, and others not depicted, may be configured to perform various aspects of the methods described herein.

Generally, processing system 600 and/or components thereof may be configured to perform the methods described herein.

Notably, in other aspects, aspects of processing system 600 may be omitted, such as where processing system 600 is a server computer or the like. Further, aspects of processing system 600 may be distributed, such as training a model and using the model to generate inferences, such as user verification predictions.

### EXAMPLE CLAUSES

Implementation details of various aspects of the present disclosure are described in the following numbered clauses.

Clause 1: A processor-implemented method, comprising: training a first neural network to perform a task based on weights defined for a machine learning model trained to perform a different task and learned reparameterizing weights for each of a plurality of layers in the machine learning model; training a second neural network to generate a plurality of gating parameters based on a cost factor and the trained first neural network, each respective gating parameter of the plurality of gating parameters corresponding to the learned reparameterizing weights in a respective layer of the plurality of layers in the machine learning model; and updating the machine learning model based on the weights defined for the machine learning model, each gating parameter for each layer of the plurality of layers in the machine learning model, and the learned reparameterizing weights for each layer of the plurality of layers in the machine learning model.

Clause 2: The method of Clause 1, wherein training the first neural network comprises training the first neural network with a target task loss value.

Clause 3: The method of Clause 1 or 2, wherein training the second neural network comprises training the second neural network based on a target cost input and a policy loss value.

Clause 4: The method of Clause 3, wherein the policy loss value is calculated based on an average Gumbel loss over the plurality of layers in the machine learning model and the target cost input.

Clause 5: The method of Clause 4, wherein the average Gumbel loss comprises an average of a product of a layer-wise weighting for a respective layer in the machine learning model based on a number of parameters in the weights defined for the machine learning model and a Gumbel loss for the respective layer.

Clause 6: The method of Clause 4 or 5, wherein a total loss used in training the second neural network is based on a target task loss value and a product of the policy loss value and a loss weighting hyperparameter.

Clause 7: The method of any of Clauses 1 through 6, wherein updating the machine learning model comprises binarizing the generated plurality of gating parameters, a value of the gating parameter for a respective layer that is less than a threshold value does not modify weights for the respective layer, and a value of the gating parameter for the respective layer that is greater than the threshold value modifies the weights for the respective layer by a respective learned reparameterizing weight.

Clause 8: The method of any of Clauses 1 through 7, wherein the second neural network comprises a network including a plurality of linear layers and a non-linear layer comprising a rectified linear unit (ReLU).

Clause 9: A processor-implemented method, comprising: extracting features from an input for which an inference is to be generated; generating the inference based on the extracted features from the input and a machine learning model having weights defined for each respective layer in the machine learning model based on base weights defined for each respective layer in the machine learning model, a gating parameter for each respective layer in the machine learning model, and reparameterizing weights for each respective layer in the machine learning model; and taking one or more actions based on the generated inference.

Clause 10: The method of Clause 9, wherein the machine learning model comprises a model having been generated based on a first neural network trained based on a target loss value and a second neural network trained based on a target cost input and a policy loss value.

Clause 11: The method of Clause 10, wherein the policy loss value is calculated based on an average Gumbel loss over the plurality of layers in the machine learning model and the target cost input.

Clause 12: The method of Clause 10 or 11, wherein the second neural network is further trained based on a target task loss value and a product of the policy loss value and a loss weighting hyperparameter.

Clause 13: The method of any of Clauses 9 through 12, wherein the machine learning model comprises a plurality of transferred layers from a base machine learning model identified based on a binarization of a plurality of gating parameters, a value of the gating parameter for a respective layer that is less than a threshold value does not modify weights for the respective layer, and a value of the gating parameter for the respective layer that is greater than the threshold value modifies the weights for the respective layer by a respective learned reparameterizing weight.

Clause 14: The method of any of Clauses 9 through 13, wherein the machine learning model comprises a network including a plurality of linear layers and a non-linear layer comprising a rectified linear unit (ReLU).

Clause 15: The method of any of Clauses 9 through 14, wherein the one or more actions comprise an action different from an action for which the machine learning model was originally trained.

Clause 16: The method of any of Clauses 9 through 15, wherein the one or more actions comprise segmenting visual content into one or more segments, each segment of the one or more segments corresponding to different classes of objects present in a scene captured in the visual content.

Clause 17: The method of Clause 16, wherein the one or more actions further comprise controlling one or more physical devices based on the segmented visual content.

Clause 18: A processing system comprising: a memory comprising computer-executable instructions; and one or more processors configured to execute the computer-executable instructions and cause the processing system to perform a method in accordance with any of Clauses 1 through 17.

Clause 19: A processing system comprising means for performing a method in accordance with any of Clauses 1 through 17.

Clause 20: A non-transitory computer-readable medium comprising computer-executable instructions that, when executed by one or more processors of a processing system, cause the processing system to perform a method in accordance with any of Clauses 1 through 17.

Clause 21: A computer program product embodied on a computer-readable storage medium comprising code for performing a method in accordance with any of Clauses 1 through 17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
training a first neural network to perform a task based on weights defined for a machine learning model trained to perform a different task and learned reparameterizing weights for each of a plurality of layers in the machine learning model;
training a second neural network to generate a plurality of gating parameters based on a cost factor and the trained first neural network, each respective gating parameter of the plurality of gating parameters corresponding to the learned reparameterizing weights in a respective layer of the plurality of layers in the machine learning model; and
updating the machine learning model based on the weights defined for the machine learning model, each gating parameter for each layer of the plurality of layers in the machine learning model, and the learned reparameterizing weights for each layer of the plurality of layers in the machine learning model.

2. The method of claim 1, wherein training the first neural network comprises training the first neural network with a target task loss value.

3. The method of claim 1, wherein training the second neural network comprises training the second neural network based on a target cost input and a policy loss value.

4. The method of claim 3, wherein the policy loss value is calculated based on an average Gumbel loss over the plurality of layers in the machine learning model and the target cost input.

5. The method of claim 4, wherein the average Gumbel loss comprises an average of a product of a layer-wise weighting for a respective layer in the machine learning model based on a number of parameters in the weights defined for the machine learning model and a Gumbel loss for the respective layer.

6. The method of claim 4, wherein a total loss used in training the second neural network is based on a target task loss value and a product of the policy loss value and a loss weighting hyperparameter.

7. The method of claim 1, wherein:
updating the machine learning model comprises binarizing the generated plurality of gating parameters,
a gating parameter for a respective layer that is less than a threshold value does not modify weights for the respective layer, and
a gating parameter for the respective layer that is greater than the threshold value modifies the weights for the respective layer by a respective learned reparameterizing weight.

8. The method of claim 1, wherein the second neural network comprises a network including a plurality of linear layers and a non-linear layer comprising a rectified linear unit (ReLU).

9. A processor-implemented method, comprising:
extracting features from an input for which an inference is to be generated;
generating the inference based on the extracted features from the input and a machine learning model having weights defined for each respective layer in the machine learning model based on base weights defined for each respective layer in the machine learning model, a gating parameter for each respective layer in the machine learning model, and reparameterizing weights for each respective layer in the machine learning model; and
taking one or more actions based on the generated inference.

10. The method of claim 9, wherein the machine learning model comprises a model having been generated based on a first neural network trained based on a target loss value and a second neural network trained based on a target cost input and a policy loss value.

11. The method of claim 10, wherein the policy loss value is calculated based on an average Gumbel loss over a plurality of layers in the machine learning model and the target cost input.

12. The method of claim 10, wherein the second neural network is further trained based on a target task loss value and a product of the policy loss value and a loss weighting hyperparameter.

13. The method of claim 9, wherein:
the machine learning model comprises a plurality of transferred layers from a base machine learning model identified based on a binarization of a plurality of gating parameters;
a value of the gating parameter for a respective layer that is less than a threshold value does not modify weights for the respective layer; and
a value of the gating parameter for the respective layer that is greater than the threshold value modifies the weights for the respective layer by a respective learned reparameterizing weight.

14. The method of claim 9, wherein the machine learning model comprises a network including a plurality of linear layers and a non-linear layer comprising a rectified linear unit (ReLU).

15. The method of claim 9, wherein the one or more actions comprise an action different from an action for which the machine learning model was originally trained.

16. The method of claim 9, wherein the one or more actions comprise segmenting visual content into one or more segments, each segment of the one or more segments corresponding to different classes of objects present in a scene captured in the visual content.

17. The method of claim 16, wherein the one or more actions further comprise controlling one or more physical devices based on the segmented visual content.

18. A system, comprising:
a memory having executable instructions stored thereon; and
a processor configured to execute the executable instructions in order to cause the system to:
train a first neural network to perform a task based on weights defined for a machine learning model trained to perform a different task and learned reparameterizing weights for each of a plurality of layers in the machine learning model;
train a second neural network to generate a plurality of gating parameters based on a cost factor and the trained first neural network, each respective gating parameter of the plurality of gating parameters corresponding to the learned reparameterizing weights in a respective layer of the plurality of layers in the machine learning model; and
update the machine learning model based on the weights defined for the machine learning model, each gating parameter for each layer of the plurality of layers in the machine learning model, and the learned reparameterizing weights for each layer of the plurality of layers in the machine learning model.

19. The system of claim 18, wherein in order to train the first neural network, the processor is configured to cause the system to train the first neural network with a target task loss value.

20. The system of claim 18, wherein in order to train the second neural network, the processor is configured to cause the system to train the second neural network based on a target cost input and a policy loss value.

21. The system of claim 20, wherein the policy loss value is calculated based on an average Gumbel loss over the plurality of layers in the machine learning model and the target cost input.

22. The system of claim 21, wherein the average Gumbel loss comprises an average of a product of a layer-wise weighting for a respective layer in the machine learning model based on a number of parameters in the weights defined for the machine learning model and a Gumbel loss for the respective layer.

23. The system of claim 21, wherein a total loss used in training the second neural network is based on a target task loss value and a product of the policy loss value and a loss weighting hyperparameter.

24. The system of claim 18, wherein:
in order to update the machine learning model, the processor is configured to cause the system to binarize the generated plurality of gating parameters;
a value of the gating parameter for a respective layer that is less than a threshold value does not modify weights for the respective layer; and
a value of the gating parameter for the respective layer that is greater than the threshold value modifies the weights for the respective layer by a respective learned reparameterizing weight.

25. The system of claim 18, wherein the second neural network comprises a network including a plurality of linear layers and a non-linear layer comprising a rectified linear unit (ReLU).

26. A system, comprising:
a memory having executable instructions stored thereon; and
a processor configured to execute the executable instructions in order to cause the system to:
extract features from an input for which an inference is to be generated;
generate the inference based on the extracted features from the input and a machine learning model having weights defined for each respective layer in the machine learning model based on base weights defined for each respective layer in the machine learning model, a gating parameter for each respective layer in the machine learning model, and reparameterizing weights for each respective layer in the machine learning model; and
take one or more actions based on the generated inference.

27. The system of claim 26, wherein:
the machine learning model comprises a plurality of transferred layers from a base machine learning model identified based on a binarization of a plurality of gating parameters;
a gating parameter for a respective layer that is less than a threshold value does not modify weights for the respective layer; and
a gating parameter for the respective layer that is greater than the threshold value modifies the weights for the respective layer by a respective learned reparameterizing weight.

28. The system of claim 26, wherein the machine learning model comprises a network including a plurality of linear layers and a non-linear layer comprising a rectified linear unit (ReLU).

29. The system of claim 26, wherein the one or more actions comprise an action different from an action for which the machine learning model was originally trained.

30. The system of claim 26, wherein the one or more actions comprise segmenting visual content into one or more segments, each segment of the one or more segments corresponding to different classes of objects present in a scene captured in the visual content.
